(19) United States
(12) Patent Application Publication
(10) Pub. No.: US 2019/0119155 A1
(43) Pub. Date: Apr. 25, 2019

(54) HEAT TREATABLE ANTIREFLECTIVE GLASS SUBSTRATE AND METHOD FOR MANUFACTURING THE SAME

(71) Applicants: AGC GLASS EUROPE, Louvain-La-Neuve (BE); AGC GLASS COMPANY NORTH AMERICA, Alpharetta, GA (US); AGC Inc, Chiyoda-ku (JP); QUERTECH INGENIERIE, Caen (FR)

(72) Inventors: Benjamine NAVET, Lauvain-La-Neuve (BE); Pierre BOULANGER, Couthuin (BE)

(73) Assignees: AGC GLASS EUROPE, Louvain-La-Neuve (BE); AGC GLASS COMPANY NORTH AMERICA, Alpharetta, GA (US); AGC Inc., Chiyoda-ku (JP); QUERTECH INGENIERIE, Caen (FR)

(21) Appl. No.: 16/092,638

(22) PCT Filed: Mar. 13, 2017
(86) PCT No.: PCT/EP2017/055849

§ 371 Date: Oct. 10, 2018

(30) Foreign Application Priority Data
Apr. 12, 2016 (EP) 16164908.2

(51) Int. Cl. C03C 23/00; C03C 3/097; C03C 3/091; C03C 3/087

(52) U.S. Cl. CPC C03C 23/0055; C03C 3/097; C03C 2203/52; C03C 3/087; C03C 3/091

(57) ABSTRACT

The invention concerns a method for manufacturing heat treatable antireflective glass substrates by ion implantation, comprising selecting a source gas of N₂, O₂, or Ar, ionizing the source gas so as to form a mixture of single charge and multicharge ions of Ar, N, or O, forming a beam of single charge and multicharge ions of Ar, N, or O by accelerating with an acceleration voltage comprised between 15 kV and 60 kV and setting the ion dosage at a value comprised between 7.5×10¹⁶ and 7.5×10¹⁷ ions/cm². The invention further concerns heat treatable and heat treated antireflective glass substrates comprising an area treated by ion implantation with a mixture of simple charge and multicharge ions according to this method.

The present invention relates to an antireflective glass substrate and a method of manufacturing the same. More particularly the present invention relates to heat treatable antireflective glass substrate, that is able to withstand heat treatments such as thermal tempering, bending and annealing without increase of light reflectance. It also relates to the use of an antireflective glass substrate, particularly as glazing.

Most antireflective glass substrates are obtained by the deposition of coatings on the glass surface. Reduction of light reflectance is obtained by single layers having refractive indexes that are lower than the refractive index of the glass substrate or that have a refractive index gradient. Some antireflective coatings are stacks of multiple layers that make use of interference effects in order to obtain a significant reduction of light reflectance over the whole visible range. Other, inherently fragile coatings present a certain degree of porosity so as to obtain a low refractive index.

In some cases an operation to mechanically reinforce the glazing, such as thermal toughening of the glass sheet or sheets, becomes necessary to improve the resistance to mechanical stresses. For particular applications, it may also become necessary to give the glass sheets a more or less complex curvature by means of a bending operation at high temperature. In the processes of production and shaping glazing systems there are certain advantages to conducting these thermal treatment operations on the already treated substrate instead of heat treating an already treated substrate. These operations are conducted at a relatively high temperature and consist in particular in heating the glass sheet to a temperature higher than 560° C. in air, e.g. between 560° C. and 700° C., and in particular around 640° C. to 670° C., for a period of about 6, 8, 10, 12 or even 15 minutes, depending on the type of treatment and the thickness of the sheet. In the case of a bending treatment, the glass sheet can then be bent to the desired shape. The toughening treatment then consists of abruptly cooling the surface of the flat or bent glass sheet by air jets or cooling fluid to obtain a mechanical reinforcement of the sheet.

On one hand there are antireflective glass substrates that are necessarily heat treated to obtain their antireflective properties, these are in particular sol-gel based coatings. On the other hand there are antireflective glass substrates that require specific precautions, such as additional coating layers, so as to become “heat treatable”, that is, able to undergo a thermal treatment, such as thermal toughening and/or bending treatment without losing the optical properties it has been created for.

There is therefore a need in the art to provide a simple, inexpensive method of making an antireflective glass substrate, that has a low reflectance both before and after a heat treatment and can thus be used both as heat treated and non-heat treated antireflective glass substrate.

According to one of its aspects, the subject of the present invention is to provide a method for producing a heat treatable antireflective glass substrate.

According to another of its aspects, the subject of the present invention is to provide a method for producing a heat treated antireflective glass substrate.

According to another of its aspects, the subject of the present invention is to provide a heat treatable antireflective glass substrate.

According to another of its aspects, the subject of the present invention is to provide a heat treated antireflective glass substrate.

The invention relates to a method for producing a heat treatable antireflective glass substrate comprising the following operations
providing a source gas selected from N₂, O₂, and/or Ar,
ionizing the source gas so as to form a mixture of single charge ions and multicharge ions of N, O, and/or Ar,
accelerating the mixture of single charge ions and multicharge ions of N, O, and/or Ar with an acceleration voltage so as to form a beam of single charge ions and multicharge ions of N, O, and/or Ar, wherein the acceleration voltage is comprised between 15 kV and 60 kV and the ion dosage is comprised between comprised between 7.5×10¹⁶ and 7.5×10¹⁷ ions/cm²,
providing a glass substrate,
positioning the glass substrate in the trajectory of the beam of single charge and multicharge ions of N, O, and/or Ar.

The inventors have surprisingly found that the method of the present invention providing an ion beam comprising a mixture of single charge and multicharge ions of N, O, and/or Ar, accelerated with the same specific acceleration voltage and at such specific dosage, applied to a glass substrate, leads to a reduced reflectance and that the resulting substrate is heat treatable. This leads to a series of advantages, in particular to antireflective glass substrates that have a low reflectance both before and after a heat treatment and can thus be used in glazings both as heat treated and non-heat treated antireflective glass substrate.

Advantageously the light reflectance of the resulting glass substrate is decreased from about 8% to at most 6.5%, preferably at most 6%, more preferably at most 5.5%.

In the present invention the ion source gas chosen among O₂, Ar, N₂ and/or He is ionized so as to form a mixture of single charge ions and mufti charge ions of O, Ar, N, and/or He respectively. The mixture of single charge ions and multicharge ions is accelerated with an acceleration voltage so as to form a beam comprising a mixture of single charge ions and multicharge ions. This beam may comprise various amounts of the different O, Ar, N, and/or He ions. Preferably the beam of accelerated single charge and multicharge ions comprises N⁺, N²⁺ and N³⁺, or O⁺ and O²⁻, and/or Ar⁺, Ar²⁺ and Ar³⁺.

Example currents of the respective ions are shown in Table 1 below (measured in milli Ampère).

TABLE 1

| Ions of O | | Ions of Ar | | Ions of N | |
|---|---|---|---|---|---|
| O+ | 1.35 mA | Ar+ | 2 mA | N+ | 0.55 mA |
| O2+ | 0.15 mA | Ar2+ | 1.29 mA | N2+ | 0.60 mA |
| | | Ar3+ | 0.6 mA | N3+ | 0.24 mA |
| | | Ar4+ | 0.22 mA | | |
| | | Ar5+ | 0.11 mA | | |

The key ion implantation parameters are the ion acceleration voltage and the ion dosage.

The positioning of the glass substrate in the trajectory of the beam of single charge and multicharge ions is chosen such that certain amount of ions per surface area or ion dosage is obtained. The ion dosage, or dosage is expressed as number of ions per square centimeter. For the purpose of the present invention the ion dosage is the total dosage of single charge ions and multicharge ions. The ion beam preferably provides a continuous stream of single and multicharge ions. The ion dosage is controlled by controlling the exposure time of the substrate to the ion beam. According to the present invention multicharge ions are ions carrying more than one positive charge. Single charge ions are ions carrying a single positive charge.

In one embodiment of the invention the positioning comprises moving glass substrate and ion implantation beam relative to each other so as to progressively treat a certain surface area of the glass substrate. Preferably they are moved relative to each other at a speed comprised between 0.1 mm/s and 1000 mm/s. The speed of the movement of the glass relative to the ion implantation beam is chosen in an appropriate way to control the residence time of the sample in the beam which influences ion dosage of the area being treated.

The method of the present invention can be easily scaled up so as to treat large substrates of more than 1 m², for example by continuously scanning the substrate surface with an ion beam of the present invention or for example by forming an array of multiple ion sources that treat a moving substrate over its whole width in a single pass or in multiple passes.

According to the present invention the acceleration voltage and ion dosage are preferably comprised in the following ranges:

TABLE 1

| Parameter | general range | preferred range | most preferred range |
|---|---|---|---|
| Acceleration | 15 to 60 | 30 to 40 | 30 to 40 |
| voltage [kV] | | | |
| Ion dosage | 7.5 × 10¹⁶ | 7.5 × 10¹⁶ | 7.5 × 10¹⁶ |
| [ions/cm²] | to 7.5 × 10¹⁷ | to 5 × 10¹⁷ | to 1 × 10¹⁷ |

The inventors have found that ion sources providing an ion beam comprising a mixture of single charge and multicharge ions, accelerated with the same acceleration voltage are particularly useful as they may provide lower dosages of multicharge ions than of single charge ions. It appears that a heat treatable glass substrate having a low reflectance may be obtained with the mixture of single charge ions, having higher dosage and lower implantation energy, and multicharge ions, having lower dosage and higher implantation energy, provided in such a beam. The implantation energy, expressed in Electron Volt (eV) is calculated by multiplying the charge of the single charge ion or multicharge ion with the acceleration voltage.

In a preferred embodiment of the present invention the temperature of the area of the glass substrate being treated, situated under the area being treated is less than or equal to the glass transition temperature of the glass substrate. This temperature is for example influenced by the ion current of the beam, by the residence time of the treated area in the beam and by any cooling means of the substrate.

In a preferred embodiment of the invention only one type of implanted ions is used, the type of ion being selected among ions of N, O, or Ar. In another embodiment of the invention two or more types of implanted ions are combined, the types of ion being selected among ions of N, O, or Ar. These alternatives are covered herein by the wording “and/or”.

In one embodiment of the invention several ion implantation beams are used simultaneously or consecutively to treat the glass substrate.

In one embodiment of the invention the total dosage of ions per surface unit of an area of the glass substrate is obtained by a single treatment by an ion implantation beam.

In another embodiment of the invention the total dosage of ions per surface unit of an area of the glass substrate is obtained by several consecutive treatments by one or more ion implantation beams.

In a preferred embodiment the glass substrate is treated on both of its faces with the method according to the present invention so as to maximize the low reflectance effect.

The method of the present invention is preferably performed in a vacuum chamber at a pressure comprised between 10⁻² mbar and 10⁻⁷ mbar, more preferably at between 10⁻⁵ mbar and 10⁻⁶ mbar.

An example ion source for carrying out the method of the present invention is the Hardion+ RCE ion source from Quertech Ingénierie S.A.

The light reflectance is measured in the visible light range on the side of the substrate treated with the ion implantation method of the present invention using illuminant D65, 2°.

The present invention also relates to a method for producing a heat treated antireflective glass substrate comprising the following operations
providing a source gas selected from N₂, O₂, and/or Ar,
ionizing the source gas so as to form a mixture of single charge ions and multicharge ions of N, O, and/or Ar,
accelerating the mixture of single charge ions and multicharge ions of N, O, and/or Ar with an acceleration voltage so as to form a beam of single charge ions and multicharge ions of N, O, and/or Ar, wherein the acceleration voltage is comprised between 15 kV and 60 kV and the ion dosage is comprised between comprised between 7.5×10¹⁶ and 7.5×10¹⁷ ions/cm²,
providing a glass substrate,
positioning the glass substrate in the trajectory of the beam of single charge and multicharge ions of N, O, and/or Ar,
submitting the glass substrate to a heat treatment comprising thermal tempering, bending or annealing.

The heat treatment step preferably comprises heating the glass substrate to a temperature higher than 560° C. in air, more preferably between 560° C. and 700° C., and most preferably between 640° C. to 670° C., for a period of 4 to 20 minutes, for example for a period of about 6, 8, 10, 12 or 15 minutes, depending on the type of treatment and the thickness of the sheet. In the case of a bending treatment, the glass sheet may then be bent to the desired shape. In case of a toughening treatment the glass sheet may then be abruptly cooled on its surface by air jets or cooling fluid to obtain a mechanical reinforcement of the substrate sheet.

The inventors have found that the additional heat treatment operation leads to a maintained or further decreased reflectance of the glass substrate.

In a preferred embodiment of the present invention the reflectance of the glass substrate decreases upon heat treatment by at least 0.4%, preferably by at least 0.6%, more preferably by at least 1%.

The present invention also concerns the use of a mixture of single charge and multicharge ions of N, O, and/or Ar to decrease the reflectance of a glass substrate and at the same time to prevent the increase of reflectance upon heat treatment, the mixture of single charge and multicharge ions being implanted in the glass substrate with an ion dosage and an acceleration voltage effective to reduce the reflectance of the glass substrate and at the same time to prevent the increase of reflectance upon heat treatment.

Advantageously the mixture of single and multicharge ions of N, O, and/or Ar is used with an acceleration voltage and an ion dosage effective to reduce the reflectance of a glass substrate to at most 6.5%, preferably to at most 6%, more preferably to at most 5.5%. At the same time the mixture of single and multicharge ions of N, O, and/or Ar is effective to prevent the increase of the reflectance of a glass substrate to more than 6.5%, preferably to more than 6%, more preferably to more than 5.5% upon heat treatment.

The heat treatment preferably comprises heating the glass substrate to a temperature higher than 560° C. in air, more preferably between 560° C. and 700° C., and most preferably between 640° C. to 670° C., for a period of 4 to 20 minutes, for example for a period of about 6, 8, 10, 12 or 15 minutes, depending on the type of treatment and the thickness of the sheet. In the case of a bending treatment, the glass sheet may then be bent to the desired shape. In case of a toughening treatment the glass sheet may then be abruptly cooled on its surface by air jets or cooling fluid to obtain a mechanical reinforcement of the substrate sheet.

According to a preferred embodiment of the present invention, the mixture of single charge and multicharge ions comprises N⁺, N²⁺ and N³⁺, or O⁺ and O²⁺, and/or Ar, Ar²⁺ and Ar³⁺.

According to a preferred embodiment of the present invention, the mixture of single charge and multicharge ions of N comprises 40-70% of N⁺, 20-40% of N²⁺, and 2-20% of N³⁺. In a more preferred embodiment of the present invention, mixture of single charge and multicharge ions of N comprises a lesser amount of N³⁺ than of N⁺ and of N²⁺ each. These proportions appear to create a refractive index gradient that decreases from the core of the glass substrate towards the treated surface of the glass substrate.

According to the present invention the acceleration voltage and ion dosage effective to reduce reflectance of the glass substrate and prevent the increase of reflectance upon heat treatment are preferably comprised in the following ranges:

TABLE 2

| | | | most preferred |
|---|---|---|---|
| parameter | general range | preferred range | range |
| Acceleration voltage | 15 to 60 | 30 to 40 | 30 to 40 |
| [kV] | | | |
| Ion dosage [ions/cm²] | 7.5 × 10¹⁶ | 7.5 × 10¹⁶ | 7.5 × 10¹⁶ |
| | to 7.5 × 10¹⁷ | to 5 × 10¹⁷ | to 1 × 10¹⁷ |

According to a more preferred embodiment, the present invention also concerns the use of mixture of single charge and multicharge ions of N, O, and/or Ar to decrease the reflectance of a glass substrate and to further decrease the reflectance upon heat treatment, the mixture of single charge and multicharge ions being implanted in the glass substrate with an ion dosage and an acceleration voltage effective to reduce the reflectance of the glass substrate and to further decrease the reflectance upon heat treatment.

Advantageously the mixture of single and multicharge ions of N, O, and/or Ar is used with an acceleration voltage and an ion dosage effective to decrease the reflectance of a glass substrate to at most 6.5%, preferably to at most 6%, more preferably to at most 5.5%. At the same time the mixture of single and multicharge ions of N, O, and/or Ar is used with an acceleration voltage and an ion dosage effective to further decrease the reflectance of a glass substrate by at least 0.4%, preferably by at least 0.6%, more preferably by at least 1% upon heat treatment.

The heat treatment preferably comprises heating the glass substrate to a temperature higher than 560° C. in air, more preferably between 560° C. and 700° C., and most preferably between 640° C. to 670° C., for a period of 4 to 20 minutes, for example for a period of about 6, 8, 10, 12 or 15 minutes, depending on the type of treatment and the thickness of the sheet. In the case of a bending treatment, the glass sheet may then be bent to the desired shape. In case of a toughening treatment the glass sheet may then be abruptly cooled on its surface by air jets or cooling fluid to obtain a mechanical reinforcement of the substrate sheet.

According to a preferred embodiment of the present invention, the mixture of single charge and multicharge ions comprises N⁺, N²⁺ and N³⁺, or O⁺ and O²⁺, and/or Ar⁻, Ar²⁺ and Ar³⁺.

According to a preferred embodiment of the present invention, mixture of single charge and multicharge ions of N comprises a lesser amount of N³⁺ than of N⁺ and of N²⁺ each. In a more preferred embodiment of the present invention, the mixture of single charge and multicharge ions of N comprises 20-60% of N⁻, 15-55% of N²⁺, and 5-25% of N³⁺. These proportions appear to create a refractive index gradient that decreases from the core of the glass substrate towards the treated surface of the glass substrate.

According to the present invention the acceleration voltage and ion dosage effective to reduce reflectance of the glass substrate and further decrease reflectance upon heat treatment are preferably comprised in the following ranges:

TABLE 3

| parameter | general range | preferred range |
|---|---|---|
| Acceleration voltage [kV] | 30 to 40 | 30 to 40 |
| Ion dosage [ions/cm²] | 7.5 × 10¹⁶ | 7.5 × 10¹⁶ |
| | to 5 × 10¹⁷ | to 1 × 10¹⁷ |

The present invention also concerns an ion implanted, heat treated glass substrate having reduced reflectance and increased scratch resistance, wherein the implanted ions are ions of N, O, and/or Ar.

Advantageously the heat treated, ion implanted glass substrate of the present invention has a reflectance of at most 6.5%, preferably to at most 6%, more preferably to at most 5.5%.

The reflectance is measured on the treated side with D65 illuminant and a 2° observer angle.

In a preferred embodiment of the present invention the ions implanted in the glass substrates of the present invention are single charge and multicharge ions of N, O, and/or Ar.

Advantageously the implantation depth of the ions may be comprised between 0.1 μm and 1 μm, preferably between 0.1 μm and 0.5 μm.

The glass substrate of the present invention is usually a sheet like glass substrate having two opposing major surfaces or faces. The ion implantation of the present invention may be performed on one or both of these surfaces. The ion implantation of the present invention may be performed on part of a surface or on the complete surface of the glass substrate.

In another embodiment, the present invention also concerns glazings incorporating antireflective glass substrates of the present invention, no matter whether they are monolithic, laminated or multiple with interposed gas layers. In such embodiment, the substrate may be tinted, tempered, reinforced, bent, folded or ultraviolet filtering.

These glazings can be used both as internal and external building glazings, and as protective glass for objects such as panels, display windows, glass furniture such as a counter, a refrigerated display case, etc., also as automotive glazings such as laminated windshields, mirrors, antiglare screens for computers, displays and decorative glass.

The glazing incorporating the antireflection glass substrate according to the invention may have interesting additional properties. Thus, it can be a glazing having a security function, such as the laminated glazings. It can also be a glazing having a burglar proof, sound proofing, fire protection or anti-bacterial function.

The glazing can also be chosen in such a way that the substrate treated on one of its faces with the method according to the present invention, comprises a layer stack deposited on the other of its faces. The stack of layers may have a specific function, e.g., sun-shielding or heat-absorbing, or also having an anti-ultraviolet, antistatic (such as slightly conductive, doped metallic oxide layer) and low-emissive, such as silver-based layers of the or doped tin oxide layers. It can also be a layer having anti-soiling properties such as a very fine TiO₂ layer, or a hydrophobic organic layer with a water-repellent function or hydrophilic layer with an anti-condensation function.

The layer stack can be a silver comprising coating having a mirror function and all configurations are possible. Thus, in the case of a monolithic glazing with a mirror function, it is of interest to position an antireflective glass substrate of the present invention with the treated face as face 1 (i.e., on the side where the spectator is positioned) and the silver coating on face 2 (i.e., on the side where the mirror is attached to a wall), the antireflection stack according to the invention thus preventing the splitting of the reflected image.

In the case of a double glazing (where according to convention the faces of glass substrates are numbered starting with the outermost face), it is thus possible to use the antireflective treated face as face 1 and the other functional layers on face 2 for anti-ultraviolet or sun-shielding and 3 for low-emissive layers. In a double glazing, it is thus possible to have at least one antireflection stack on one of the faces of the substrates and at least one layer or a stack of layers providing a supplementary functionality. The double glazing can also have several antireflective treated faces, particularly at least on faces 2, 3, or 4.

The substrate may also undergo a surface treatment, particularly acid etching (frosting), the ion implantation treatment may be performed on the etched face or on the opposite face.

The substrate, or one of those with which it is associated, can also be of the printed, decorative glass type or can be screen process printed.

A particularly interesting glazing incorporating the antireflective glass substrate according to the invention is a glazing having a laminated structure with two glass substrates, comprising a polymer type assembly sheet between an antireflective glass substrate of the present invention, with the ion implantation treated surface facing away from the polymer assembly sheet, and another glass substrate. The polymer assembly sheet can be from polyvinylbutyral (PVB) type, polyvinyl acetate (EVA) type or polycyclohexane (COP) type. Preferably, the another glass substrate is an antireflective glass substrate according to the present invention.

This configuration, particularly with two heat treated, that is bent and/or tempered, substrates, makes it possible to obtain a car glazing and in particular a windshield of a very advantageous nature. The standards require cars to have windshields with a high light transmission of at least 75% in normal incidence. Due to the incorporation of the heat treated antireflective glass substrate in a laminated structure of a conventional windshield, the light transmission of the glazing is particularly improved, so that its energy transmission can be slightly reduced by other means, while still remaining within the light transmission standards. Thus, the sun-shielding effect of the windshield can be improved, e.g., by absorption of the glass substrates. The light reflection value of a standard, laminated windshield can be brought from 8% to less than 3%.

The glass substrate according to this invention may be a glass sheet of any thickness having the following composition ranges expressed as weight percentage of the total weight of the glass:

| | |
|---|---|
| SiO₂ | 35-85%, |
| Al₂O₃ | 0-30%, |
| P₂O₅ | 0-20%, |
| B₂O₃ | 0-20%, |
| Na₂O | 0-25%, |
| CaO | 0-20%, |
| MgO | 0-20%, |
| K₂O | 0-20%, and |
| BaO | 0-20%. |

The glass substrate according to this invention is preferably a glass sheet chosen among a soda-lime glass sheet, a borosilicate glass sheet, or an aluminosilicate glass sheet.

The glass substrate according to this invention preferably bears no coating on the side being subjected to ion implantation.

The glass substrate according to the present invention may be a large glass sheet that will be cut to its final dimension after the ion implantation treatment or it may be a glass sheet already cut to its final size.

Advantageously the glass substrate of the present invention may be a float glass substrate. The ion implantation method of the present invention may be performed on the air side of a float glass substrate and/or the tin side of a float glass substrate. Preferably the ion implantation method of the present invention is performed on the air side of a float glass substrate.

The optical properties were measured using a Hunterlab Ultrascan Pro Spectrophotometer, before and after heat treatment.

### DETAILED DESCRIPTION OF PARTICULAR EMBODIMENTS

The ion implantation examples were prepared according to the various parameters detailed in the tables below using an RCE ion source for generating a beam of single charge and multicharge ions. The ion source used was a Hardion+ RCE ion source from Quertech Ingénierie S.A.

All samples had a size of 10×10cm² and were treated on the entire surface by displacing the glass substrate through the ion beam at a speed between 20 and 30 mm/s.

The temperature of the area of the glass substrate being implanted was kept at a temperature less than or equal to the glass transition temperature of the glass substrate.

For all examples the implantation was performed in a vacuum chamber at a pressure of 10⁻⁶ mbar.

Using the RCE ion source, ions of N and O were implanted in 4 mm thick regular dear soda-lime glass and alumino-silicate glass substrates. Before being implanted with the ion implantation method of the present invention the reflectance of the glass substrates was about 8%. The key implantation parameters, and measured reflectance measurements can be found in the tables below.

A heat treatment was performed on examples of the present invention by heating them in a static furnace at 670° C. for 4 minutes. These heat treatment parameters simulate the heat load of thermal tempering for glass substrates of 4 mm thickness.

TABLE 4

| | | | | | light reflectance | light reflectance |
|---|---|---|---|---|---|---|
| | | | acceleration | ion | before heat | after heat |
| | Source | glass | voltage | dosage | treatment | treatment |
| reference | gas | substrate | [kV] | [ions/cm²] | [%, D65, 2°] | [%, D65, 2°] |
| E1 | N₂ | Sodalime | 35 | 1 × 10¹⁷ | 6.37 | 4.89 |
| E2 | N₂ | Sodalime | 35 | 7.5 × 10¹⁶ | 5.96 | 4.61 |
| E3 | O₂ | Sodalime | 35 | 1 × 10¹⁷ | 5.64 | 5.03 |

As can be seen from Table 4, examples E1, E2 and E3 of the present invention reach low reflectance not only before heat treatment but also after heat treatment. Most surprisingly they even show a further decreased light reflectance after heat treatment. Upon heat treatment, the reflectance of example E3 decreases by 0.61%, the reflectance of example E2 decreases by 0.47%, the reflectance of example E1 decreases by 1.12%.

Furthermore XPS measurements were made on the samples E1 to E3 of the present invention and it was found that the atomic concentration of implanted ions of N is below 8 atomic % throughout the implantation depth.

1. A method for producing a heat treatable antireflective glass substrate comprising:
a) providing at least one source gas selected from the group consisting of N₂, O₂, and Ar,
b) ionizing the source gas so as to form a mixture of single charge ions and multicharge ions of N, O, and/or Ar,
c) accelerating the mixture of single charge ions and multicharge ions of N, O, and/or Ar with an acceleration voltage so as to form a beam of single charge ions and multicharge ions of N, O, and/or Ar, wherein the acceleration voltage is between 15 kV and 60 kV and the ion dosage is between 7.5×10¹⁶ and 7.5×10¹⁷ ions/cm²,
d) providing a glass substrate, and
e) positioning the glass substrate in the trajectory of the beam of single charge and multicharge ions of N, O, and/or Ar.

2. The method for producing a heat treatable antireflective glass substrate according to claim 1, wherein the acceleration voltage is between 30 kV and 40 kV and the ion dosage is between 7.5×10¹⁶ and 5×10¹⁷ ions/cm².

3. The method for producing a heat treatable antireflective glass substrate according to claim 2, wherein the acceleration voltage is between 30 kV and 40 kV and the ion dosage is between 7.5×10⁶ and 1×10¹⁷ ions/cm².

4. The method for producing a heat treatable antireflective glass substrate according to claim 1 wherein the source gas is at least one selected from the group consisting of N₂ and O₂.

5. The method for producing a heat treatable antireflective glass substrate according to claim 1, wherein the glass substrate provided has the following composition ranges expressed as weight percentage of the total weight of the glass:

| | |
|---|---|
| SiO₂ | 35-85%, |
| Al₂O₃ | 0-30%, |
| P₂O₅ | 0-20% |
| B₂O₃ | 0-20%, |
| Na₂O | 0-25%, |
| CaO | 0-20%, |
| MgO | 0-20%, |
| K₂O | 0-20%, and |
| BaO | 0-20%. |

6. The method for producing a heat treatable antireflective glass substrate according to claim 5, wherein the glass substrate is selected from the group consisting of a soda-lime glass sheet, a borosilicate glass sheet and an aluminosilicate glass sheet.

7. A method for producing a heat treated antireflective glass substrate comprising:
a) providing at least one source gas selected from the group consisting of N₂, O₂, and Ar,
b) ionizing the source gas so as to form a mixture of single charge ions and multicharge ions of N, O, and/or Ar,
c) accelerating the mixture of single charge ions and multicharge ions of N, O, and/or Ar with an acceleration voltage so as to form a beam of single charge ions and multicharge ions, wherein the acceleration voltage is between 15 kV and 60 kV and the ion dosage is between 7.5×10¹⁶ and 7.5×10¹⁷ ions/cm²,
d) providing a glass substrate,
e) positioning the glass substrate in the trajectory of the beam of single charge and multicharge ions of N, O, and/or Ar, and
f) subjecting the glass substrate to a heat treatment comprising thermal tempering, bending or annealing.

8. The method for producing a heat treated antireflective glass substrate according to claim 7 wherein the heat treatment comprises heating the glass substrate to a temperature higher than 560° C. in air for a period of 4 to 20 minutes.

9. The method for producing a heat treated antireflective glass substrate according to claim 7, wherein the acceleration voltage is between 30 kV and 40 kV and the ion dosage is between 7.5×10¹⁶ and 5×10¹⁷ ions/cm².

10. The method for producing a heat treated antireflective glass substrate according to claim 9, wherein the acceleration voltage is between 30 kV and 40 kV and the ion dosage is between 7.5×10¹⁶ and 1×10¹⁷ ions/cm².

11. The method for producing a heat treated antireflective glass substrate according to claim 7, wherein the source gas is at least one selected from the group consisting of N₂ and O₂.

12. The method for producing a heat treated antireflective glass substrate according to claim 7, wherein the glass substrate provided has the following composition ranges expressed as weight percentage of the total weight of the glass:

| | |
|---|---|
| SiO₂ | 35-85%, |
| Al₂O₃ | 0-30%, |
| P₂O₅ | 0-20%, |
| B₂O₃ | 0-20%, |
| Na₂O | 0-25%, |
| CaO | 0-20%, |
| MgO | 0-20%, |
| K₂O | 0-20%, and |
| BaO | 0-20%. |

13. The method for producing a heat treated antireflective glass substrate according to claim 12, wherein the glass substrate is selected from the group consisting of a soda-lime glass sheet, a borosilicate glass sheet and an aluminosilicate glass sheet.

14-20. (canceled)

21. A heat treatable antireflective glass substrate produced by the method according to claim 1.

22. A heat treated antireflective glass substrate produced by the method according to claim 7.

23. A monolithic glazing, laminated glazing or multiple glazing with interposed gas layer, comprising the heat treatable antireflective glass substrate according to claim 21.

24. The glazing of claim 23, further comprising sun-shielding, heat-absorbing, anti-ultraviolet, antistatic, low-emissive, heating, anti-soiling, security, burglar proof, sound proofing, fire protection, anti-mist, water-repellant, anti-bacterial or mirror means.

25. The glazing of claim 23, wherein said antireflective glass substrate is frosted, printed or screen process printed.

26. The glazing of claim 23, wherein said substrate is tinted, tempered, reinforced, bent, folded or ultraviolet filtering.

27. The glazing of claim 23, having a laminated structure comprising a polymer assembly sheet interposed between the antireflective glass substrate, with an ion implantation treated surface facing away from the polymer assembly sheet, and another glass substrate.

28. The glazing of claim 27, wherein said glazing is a car windshield.
